(19) United States
(12) Patent Application Publication
(10) Pub. No.: US 2020/0387218 A1
(43) Pub. Date: Dec. 10, 2020

(54) METHOD AND A HMD FOR DYNAMICALLY ADJUSTING A HUD

(71) Applicant: Tobii AB, Danderyd (SE)

(72) Inventor: Geoffrey Cooper, Danderyd (SE)

(73) Assignee: Tobii AB, Danderyd (SE)

(21) Appl. No.: 16/777,537

(22) Filed: Jan. 30, 2020

(30) Foreign Application Priority Data
Jan. 30, 2019 (SE) 1950107-1

(51) Int. Cl. G06F 3/01; G06T 19/00; G06T 19/20

(52) U.S. Cl. CPC G06F 3/013; G06T 2219/2016; G06T 19/20; G06T 19/006

(57) ABSTRACT

The embodiments herein relate to a method and a Head-Mounted-Device (HMD) for adaptively adjusting a Head-Up-Display (HUD), wherein the HUD includes a User Interface (UI) or HUD graphics the HMD comprising at least one eye tracker, a processor and a memory containing instructions executable by the processor wherein the HMD is operative to: determine a fixation distance, being a distance to a fixation point a user of said HUD is fixating on; and dynamically adjust said HUD by adjusting the position of the HUD UI, in front of each eye of the user, such that the HUD UI appears to be positioned at the fixation distance.

### CROSS-REFERENCES TO RELATED APPLICATIONS

This application claims priority to Swedish Application No. 1950107-1, filed Jan. 30, 2019; the content of which are hereby incorporated by reference.

### TECHNICAL FIELD

The present disclosure relates to displays, and in particular to it relates to a wearable Head-Mounted-Device (HMD) and a method for dynamically adjusting a Head-Up-Display (HUD) of the HMD that stays in focus.

### BACKGROUND

Wearable systems may integrate various elements, such as miniaturized computers, input devices, sensors, detectors, image displays, wireless communication devices as well as image and audio sensors, into a device that can be worn by a user.

By placing an image display element close to the wearer's eye(s), an artificial image can be made to overlay the wearer's view of the real world. Such image display elements are incorporated into systems also referred to as “near-eye displays”, or HMDs or HUDs. Depending upon the size of the display element and the distance to the wearer's eye, the artificial image may fall or nearly fill the wearer's field of view.

When wearing an HMD, User Interface (UI) elements are generally used to display information that is relevant to the user. It is useful for some UI information to stay visible in the user's field of view when they look around (HUD UI). A HUD UI can appear fixed in relation to the HMD. Examples of a HUD UI are notifications, text and number readouts, icons, images, etc.

Current HMDs glasses display HUDs at a fixed virtual distance roughly 1 m away from the glasses. If a user is looking at something close (e.g. reading a book), and the user wants to look at the HUD, then the user will have to diverge the eyes from ˜0.5 m (reading distance) to ˜1 m (HUD distance) in order to focus on the HUD. Similarly, if the user is looking at something far away (e.g. looking at a building in the distance), then the user will have to converge the eyes from ˜100 m (building distance) to ˜1 m (HUD distance) in order to focus on the HUD. Converging and diverging the eyes to look at the HUD causes eye strain and it takes time for the eyes to adjust to the new distance. This is uncomfortable for the user. Further this can cause the user to miss an important visual cue while the eyes are adjusting.

### SUMMARY

It is an object of embodiments herein to solve the above problems by providing a method and a HMD for dynamically adjusting the HUD of the HMD.

According to an aspect of embodiments herein, there is provided a method, in a HMD, for adaptively adjusting a HUD, wherein the HUD includes a UI, the method comprising: determining a fixation distance, being a distance to a fixation point a user of said HUD is fixating on; dynamically adjusting said HUD by adjusting the position of the HUD UI, in front of each eye of the user, such that the HUD UI appears to be positioned at the fixation distance.

According to an embodiment, dynamically adjusting said HUD includes, adjusting the position of the HUD UI by maintaining the HUD UI at approximately the same visual size in the user's field of view.

As an exemplary embodiment, the adjustment of said HUD comprises moving, in a virtual space, the HUD UI to the fixation distance and scaling the size of the HUD UI to maintain approximately the same visual size in the user's field of view as before said moving, wherein scaling includes multiplying a HUD scale by the fixation distance.

According to another aspect of embodiments herein, there is provided a HMD, for adaptively adjusting a HUD, wherein the HUD includes a UI, the HMD comprising at least one eye tracker, a processor and a memory containing instructions executable by the processor wherein the HMD is operative to: determine a fixation distance, being a distance to a fixation point a user of said HUD is fixating on; and dynamically adjust said HUD by adjusting the position of the HUD UI, in front of each eye of the user, such that the HUD UI appears to be positioned at the fixation distance.

There is also provided a HUD operated by a HMD according to embodiments herein.

There is also provided a computer program comprising instructions which when executed on at least one processor of the HMD according embodiments herein, cause the processor to carry out the method according to the present embodiments.

There is also provided a carrier containing the computer program, wherein the carrier is one of a computer readable storage medium; an electronic signal, optical signal or a radio signal.

An advantage with the embodiments herein is to at least reduce eye strain for a user, caused by re-focusing the lenses of the eyes (accommodation).

Another advantage is to reduce the time needed to focus on the HUD, and to avoid changing vergence.

Additional advantages achieved by the embodiments herein will become apparent from the following detailed description when considered in conjunction with the accompanying drawings.

### BRIEF DESCRIPTION OF THE DRAWINGS

Example of embodiments herein are described in more detail with reference to the attached drawings in which:

FIG. 1 is a general view from the perspective of the user wearing the HMD while keeping the same visual size achieved according to embodiments herein.

FIG. 2A is a perspective view depicting HUD graphics seen by the user wearing the HMD.

FIG. 2B is a top view depicting HUD graphics by the same user wearing the HMD.

FIG. 2C is a schematic view depicting movements of the HUD UI or graphics outward and inward respectively achieved by the embodiments herein.

FIG. 3 illustrates a flowchart of a method performed in a HMD according to embodiments herein.

### DETAILED DESCRIPTION

In the following, a detailed description of the exemplary embodiments is presented in conjunction with the drawings to enable easier understanding of the solution(s) described herein.

The following explanations are presented for Head-Mounted-Device, HMD, and Heads-Up-Display, HUD, respectively:

Head-Mounted-Device, HMD:

Augmented Reality (AR) Glasses, Smart Glasses, or Virtual Reality (VR)—these could be generalized as Head-Mounted-Devices (HMDs):
eye trackers are generally included in HMDs
AR glasses or HMDs may have outward facing camera(s)/sensors that may track the environment (e.g. Simultaneous Localization And Mapping, SLAM/Inside-out tracking), which may be used to determine known points of the environment in world-space coordinates. These points may be used to construct a 3D mesh of the environment.
the HMD may be a fixed focus display (fixed focal distance, most common today), or adaptive focus display (supports multiple focal distances, will probably be more common in the future). The dynamic HUD solution, according to an embodiment herein, may have more user benefit in adaptive focus displays, compared to in fixed focus displays. To see the dynamic HUD clearly in a fixed-focus display, the user doesn't have to change its vergence, but the user will usually have to change its eye lens accommodation. With an adaptive focal display, the user wouldn't have to change its vergence and wouldn't have to change its eye lens accommodation, to see the HUD clearly. In this case, the user may move his/her eyes from a point of interest to the HUD without the eye needing to make any optical adjustments.

Heads-Up-Display, HUD:

The HMD includes/shows a Heads-Up-Display (HUD):
Currently, most HUDs are at a relatively short focal distance to the user, and they are in a fixed position relative to the HMD.
According to an example herein, the HUD may be fixed only in the X and Y axes relative to the HMD, but may move in the Z direction. As an example, moving, in a virtual space, the HUD UI may comprise fixing the X axis and the Y axis relative to the HMD, and moving the HUD UI only in the Z direction.
The HUD may contain information that is useful or relevant to the user. For example, if a person is using the HMD in an industrial setting, the HUD could display time, real-time statistics, alerts, communications, information about gazed objects, diagrams, maps, etc.

A dynamic HUD, according to embodiments herein, would be beneficial in at least situations where visual attention is critical. This is because the user does not need to change their eyes' convergence in order to focus on the HUD. Changing convergence generally takes time, and in some cases the time taken to converge on the HUD and diverge back to the user's point of interest could be critical—something could happen during that time. Changing convergence also changes the focal distance of the user's eyes, and everything that is at a different focal distance than the HUD will appear out of focus. This means that, for example, if the user is focusing at a point of interest far away and then converges his/her eyes on a near HUD, the HUD will be in focus but the user's previous point of interest will be out of focus, which could result in the user not seeing a critical change at the previous point of interest.

Some examples of domains that require focused visual attention and require the user to regularly look at different things that have different focal distances
construction
engineering
medical
transport (e.g. driving)
sports (e.g. skiing), etc.

According to embodiments herein, the HUD may be dynamically adjusted while the user shifts between looking at closer things/objects or objects at a distance, i.e. when the vergence of the eyes of the user changes. A vergence is defined as the simultaneous movement of the pupils of the eyes towards or away from one another during focusing. The HUD may always appear at the convergence distance of the user's eyes, no matter where he or she is looking. For example, if the user is looking at a building or an object in the distance, and then looks at the HUD, the HUD UI will appear to be positioned at the same fixation distance and therefore the user does not have to change convergence, resulting in less eye strain and less time needed to focus on the HUD.

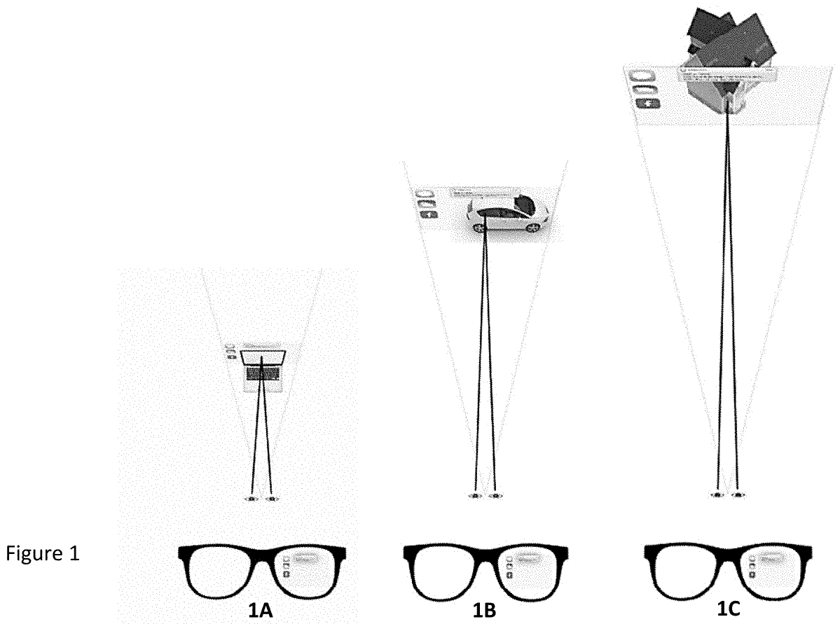

Hence, instead of having a HUD at a fixed distance (many current HUDs are configured this way), the HUD virtually moves to a fixation distance. FIG. 1 illustrates a dynamic focus HUD showing how the HUD UI of a HMD (glasses) of a user maintains approximately the same visual size in the user's field of view according to embodiments herein.

As shown, the HUD UI changes the distance to a fixation point in scenarios 1A, 1B, and 10, in order to match the user's convergence distance. The HUD UI in the HMD worn by the user keeps the same visual size independently of the distance to the object the user is looking at which here is exemplified as:

A short distance to a computer 1A, a larger distance to a car 1B and a greater distance to a house 10. The position of the HUD UI is dynamically adjusted, in front of each eye of the user, such hat the HUD UI appears to be positioned at a fixation distance being a distance to a fixation point a user of said HUD is fixating on and which is determined by the HMD.

The scale of the HUD also changes in order to keep the same visual size in your glasses. By doing so, a user doesn't have to converge or diverge his/her eyes to see the HUD or the HUD UI clearly. Instead, the HUD follows the convergence distance, so the user just needs to look at the HUD, without changing convergence of the eyes. This saves the user from eye strain and also saves the time needed to refocus the eyes. It should be mentioned that maintaining the HUD UI at approximately the same visual size in the user's field of view may be defined as maintaining the same real-world size in terms of pixels on the screen since the virtual size may vary, thereof the use of the term “approximately”.

Since the movement and scale of the HUD UI is not easy to perceive, it just looks like it stays the same size. Therefore, in accordance with an embodiment, to make the movement and scale completely imperceptible, it should be possible to dynamically move and scale the HUD during e.g. saccades.

According to an embodiment, dynamically adjusting the HUD comprises moving, in a virtual space, the HUD UI to the fixation distance; and scaling the size of the HUD UI to maintain approximately the same visual size in the user's field of view as before said moving, wherein scaling includes multiplying a HUD scale by the fixation distance.

As an example, the size and distance of the HUD may change during every rendered frame of a 3D engine. This may be a continuous calculation that may be run the whole time when the HUD is shown to the user.

The scaling of the size of the HUD UI may be defined as: Size=Distance*FixedSize, wherein: Size is the virtual size of the HUD (or HUD UI). For a 2D HUD, the size would be presented by a two dimensional (2D) scale (Vector2). For a 3D HUD, the size would be presented by a three dimensional scale (3D) (Vector3). Distance is the distance from the HMD to the fixation point i.e. Distance is the fixation distance. In a 3D engine, this could also be expressed as the distance from a virtual camera to the fixation point.

FixedSize is a constant value or the HUD scale which defines the perceived visual size of the HUD. FixedSize can be any desired value, but it usually wouldn't change during the continuous calculation. The HUD scale (selectable by the implementer) will be multiplied by the fixation distance as shown below.

In the following, different scenarios are described, including how the distance to a fixation point a user of the HUD is fixating on is determined, in accordance with some exemplary embodiments. Assuming that a user is wearing a HMD, with HUD graphics or a HUD UI: The user fixates on a point. The distance to the fixation point (could also be called focal distance or convergence distance) may be determined by: an intersection point of gaze rays or a minimal distance between the gaze rays originating from the left and right eye: with eye trackers provided around each HMD lens, a gaze direction may be estimated for each eye. The intersection point of gazes may be determined if lines are drawn in these directions in a 3D space, the closest point or a minimal distance between the gaze rays between two lines may be found. This achieves a 3D fixation point in front of the user. Alternatively, the distance between the eyes and the fixation point gives an estimate of the distance to the point where the user is looking.

The distance to the fixation point may be determined by a convergence distance from Inter-Pupillary Distance (IPD): determining the fixation distance may be performed by using an IPD between the pupils of the user, an Inter-Ocular-Distance, IOD, between the eyes of the user, and an approximation of the eye ball diameter of each of the eyes. when the user is looking into the distance (optical infinity), the IPD may be recorded, according to the eye tracker's pupil in sensor signal, PIS, which is defined as the relative position of the pupil to the eye tracking ring. The convergence distance may be determined as the user looks at a convergence distance closer than optical infinity, the IPD value may decrease, which means that they are converging on something closer. The Convergence Point from IPD algorithm may estimate the distance at which the user is looking.

The distance to the fixation point may be determined by using raycasting against a SLAM mesh to get the hit point: determining the fixation distance may be performed by acquiring the distance to a 3D mesh map of the environment: As an example, in AR glasses or HMDs, positional tracking may be used to determine where the HMD is located relative to its environment. To determine the HMD's location, sensors on the HMD find the 3D location of known points in the world. These points have a known distance from the HMD. These points can be turned into a 3D polygon mesh: once the 3D mesh is known, a line may be drawn in the direction of the user's gaze (raycast). As another example, the intersection point of the line (or a minimal distance between gaze rays) and the mesh may give a 3D fixation point in the world-space. The distance between the eyes and the fixation point may give an estimate of the distance to the point where the user is looking; the above may be performed in a 3D engine.

After the distance to the fixating point has been determined the HUD UI, in the virtual space, may be moved to the same distance as the fixation point. The HUD UI may be scaled to keep the same visual size to the user, by multiplying the HUD scale by the convergence distance, as previously described. When the user looks at the HUD UI, the user sees the HUD UI at the same distance as their fixation point, which means the user can comfortably look at it without having to change convergence.

If raycasting is used as explained above, fixation points may be detected by a fixation point algorithm (there are several exemplary algorithms that may do this): at any given time, the most recent fixation point may be stored. When the user changes gaze point from a fixation point (non-HUD) to the HUD UI, the system detects that the user is looking at the HUD UI, as determined by the intersection of a gaze raycast ray with the HUD UI elements. The HUD UI keeps the distance of the last fixation point. The reason to do this is that a raycast will always start from the eyes in the direction of gaze, and keep going until it hits a 3D mesh. When gazing between an object, close to the user, and a HUD UI or HUD graphics at the same depth, there may be a gap in between where the 3D mesh is far away. (e.g. if one holds a coffee cup in front of a distant landscape, and changes gaze point from the coffee cup to the HUD graphics, the raycast may hit the distant landscape during the eye saccade). While continuing to look at the HUD UI, the HUD does not change distance or scale. When the user looks away from the HUD, it unfreezes and continues to adjust.

The HUD shouldn't need to ‘freeze’, because it's always at the user's focal distance. This applies in the case the distance to the fixation point is determined by using the intersection point of gaze rays or by the convergence distance from IPD as previously described.

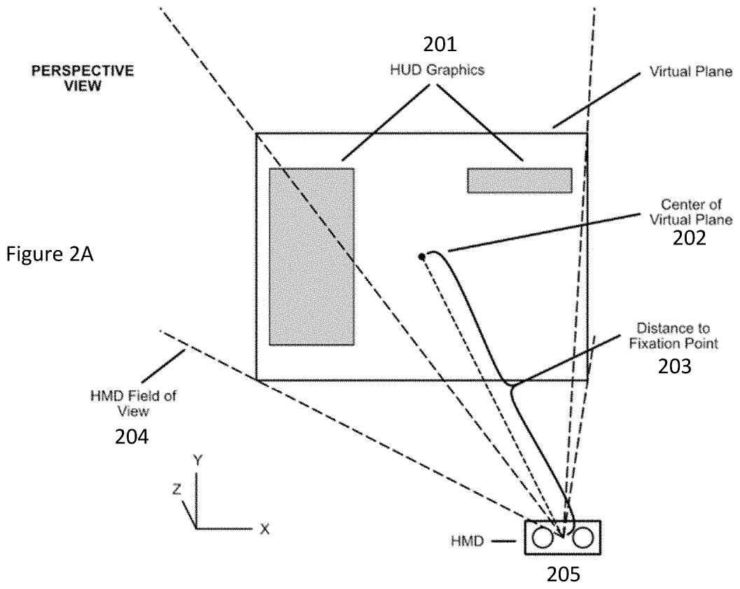

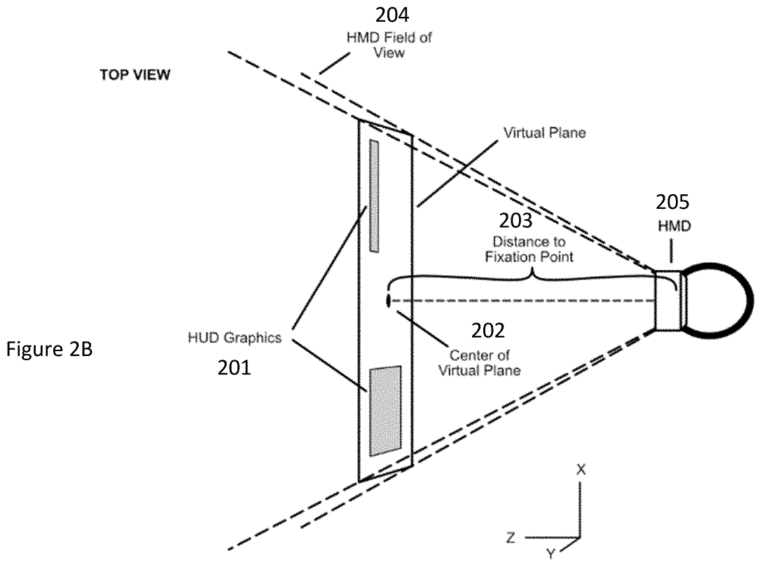

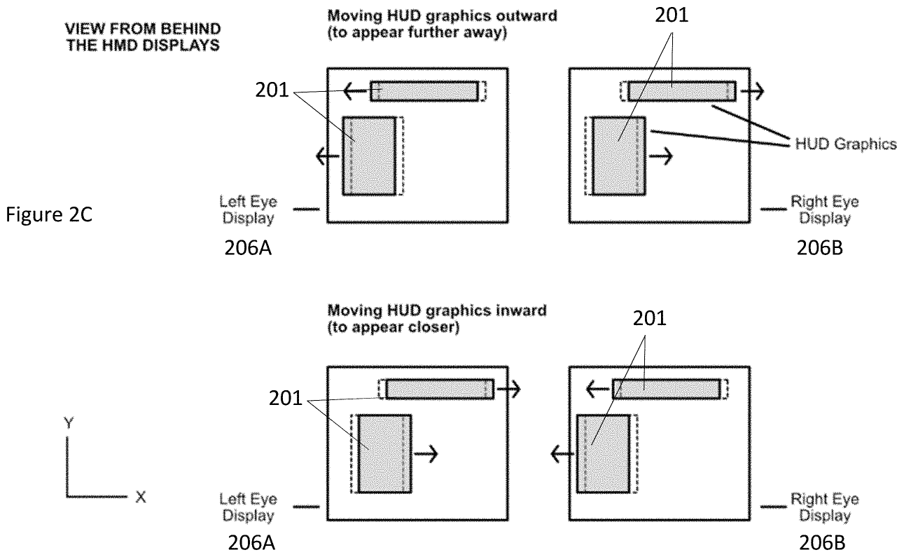

Referring to FIGS. 2A-2C there are illustrated a perspective view, a top view and a schematic view respectively of moving HUD UI or HUD graphics outward and inward respectively in accordance with previously described embodiments. The HUD graphics 201 shown in FIGS. 2A and 2B are shown being moved outward (to appear further away) and inward (to appear closer) as shown in FIG. 2C. The HMD 205 is also shown in FIGS. 2A and 2B and the HMD Field of view 204 is schematically shown as well as the focal distance 203 from the HMD 205. The focal distance is also denoted distance to fixation point 203. The center of virtual plane 202 is also depicted. The virtual plane is also shown.

Additional details have already been disclosed and need not be repeated again.

In greater detail, FIGS. 2A to 2C show a HUD UI or HUD graphics 201 that may be dynamically adjusted in accordance with previously described embodiments, shown from 3 points of view. FIG. 2A shows a perspective view. FIG. 2B shows a top view. FIG. 2C shows what the user sees in the HMD 205, from a point of view just behind the HMD displays. In FIGS. 2A to 2C, the HUD UI 201 is represented by two rectangles, one to the left of the user's field of view, and one at the top of the user's field of view. 206A is the screen for the left eye of the user. In the figure, the user's field of view is both 206A (left eye display) and 206B (right eye display). In FIGS. 2A and 2B, The HUD UI is shown on a virtual plane, whose center is on a line pointing straight forwards from the HMD 205 and at the same distance as the distance to center of virtual plane 202, and whose edges meet the edges of the user's field of view 204. FIG. 2C shows how the rendered HUD UI changes in the left and right eye displays 206A, 206B respectively. The HUD UI 201 keeps the same real-world size in terms of pixels on each display, but they move outwards from the center when the gaze point moves further away from the user, and inwards towards the center when the gaze point moves closer to the user.

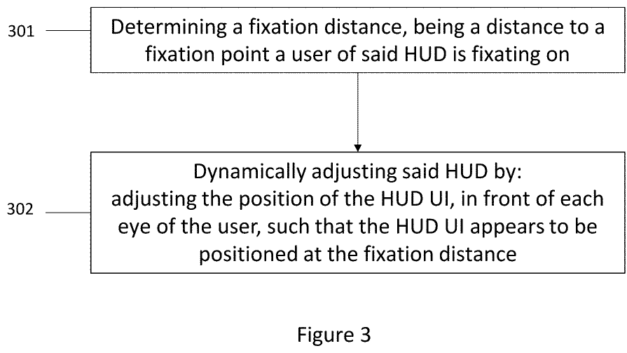

Referring to FIG. 3 there is illustrated a flowchart of a method for adaptively adjusting a HUD, wherein the HUD includes a UI and/or graphics, in accordance with previously described embodiments. The method comprising:
determining 301 a fixation distance, being a distance to a fixation point a user of said HUD is fixating on;
dynamically adjusting 302 said HUD by:
   adjusting the position of the HUD UI, in front of each eye of the user, such that the HUD UI appears to be positioned at the fixation distance.

As previously described and in accordance with an embodiment, dynamically adjusting the HUD includes, adjusting the position of the HUD UI by maintaining the HUD UI at approximately the same visual size in the user's field of view.

According to another embodiment, dynamically adjusting the HUD comprises moving, in a virtual space, the HUD UI to the fixation distance; and scaling the size of the HUD UI to maintain approximately the same visual size in the user's field of view as before said moving, wherein scaling includes multiplying a HUD scale by the fixation distance.

As previously presented, determining the fixation distance may be performed by using an intersection of or a minimal distance between gaze rays originating from the left and right eye, respectively.

Determining the fixation distance may also be performed by using an Inter-Pupillary-Distance (IPD) between the pupils of the user, an Inter-Ocular-Distance (IOD), between the eyes of the user, and an approximation of the eyeball diameter of each of the eyes.

Determining the fixation distance may also be performed by acquiring the distance to a 3D mesh map of the environment (e.g. SLAM) in the direction of the direction of the user's gaze.

According to an embodiment, the position of the HUD UI is maintained while the user continues to look at the HUD. Further, the dynamic adjustment of the HUD may be performed when the user looks away from the HUD. The adjustment may be performed during saccades as previously described.

Additional details have already been disclosed and need not be repeated again.

To perform the method described above a HMD is provided, wherein the HUD includes a UI or graphics. The HMD comprising at least one eye tracker, a processor and a memory containing instructions executable by the processor wherein the HMD is operative to:
determine a fixation distance, being a distance to a fixation point a user of said HUD is fixating on;
dynamically adjust said HUD by adjusting the position of the HUD UI, in front of each eye of the user, such that the HUD UI appears to be positioned at the fixation distance.

According to an embodiment, the HMD is operative to dynamically adjust the HUD by adjusting the position of the HUD UI, by maintaining the HUD UI at approximately the same visual size in the user's field of view.

According to another embodiment, the HMD operative to dynamically adjust said HUD by moving, in a virtual space, the HUD UI to the fixation distance; and by scaling the size of the HUD UI to maintain approximately the same visual size in the user's field of view as before said moving, wherein scaling is performed by multiplying a HUD scale by the fixation distance.

The HMD may be operative to determine the fixation distance by using an intersection of or a minimal distance between gaze rays originating from the left and right eye, respectively.

The HMD may be operative to determine the fixation distance by using an IPD between the pupils of the user, an IOD between the eyes of the user, and an approximation of the eyeball diameter of each of the eyes.

The HMD may be operative to determine the fixation distance by acquiring the distance to a 3D mesh map of the environment (e.g. SLAM).

According to an embodiment, the HMD is operative to maintain the position of the HUD UI while the user continues to look at the HUD and is operative to dynamically adjust the HUD when the user looks away from the HUD. The HMD may be operative to dynamically adjust the HUD during saccades.

According to an embodiment, the HUD may be rendered on a fixed display or an adaptive focus display.

There is also provided a HUD operated by the HMD according to previously described embodiments.

A computer program is also provided including instructions which when executed on at least one processor of the HMD, cause the at least one processor to carry out the method described above.

A carrier containing the computer program is also provided, wherein the carrier is one of a computer readable storage medium; an electronic signal, optical signal or a radio signal.

As clear from the present disclosure several advantages are achieved which include at least reducing eyestrain for a user and reducing the time needed to focus on the HUD, and to avoid changing vergence.

It is understood that while the detailed drawings, specific examples, dimensions, and particular values given provide exemplary embodiments, the embodiments are for the purpose of illustration only. The method and apparatus of the embodiments herein are not limited to the precise details and conditions disclosed. Various changes may be made to details disclosed without departing from the spirit of the invention which is defined by the following claims.

1. A method in a Head-Mounted-Device, HMD, for adaptively adjusting a Head-Up-Display, HUD, wherein the HUD includes a User Interface, UI, the method comprising:
determining a fixation distance, being a distance to a fixation point a user of said HUD is fixating on;
dynamically adjusting said HUD by:
adjusting the position of the HUD UI, in front of each eye of the user, such that the HUD UI appears to be positioned at the fixation distance.

2. The method according to claim 1, wherein dynamically adjusting said HUD includes, adjusting the position of the HUD UI by maintaining the HUD UI at approximately the same visual size in the user's field of view.

3. The method according to claim 1 wherein dynamically adjusting said HUD comprises moving, in a virtual space, the HUD UI to the fixation distance; and scaling the size of the HUD UI to maintain approximately the same visual size in the user's field of view as before said moving, wherein scaling includes multiplying a HUD scale by the fixation distance.

4. The method according to claim 1, wherein determining the fixation distance is performed by using an intersection of or a minimal distance between gaze rays originating from the left and right eye, respectively.

5. The method according to claim 1, wherein determining the fixation distance is performed by using an Inter-Pupillary-Distance, IPD, between the pupils of the user, an Inter-Ocular-Distance, IOD, between the eyes of the user, and an approximation of the eye ball diameter of each of the eyes.

6. The method according to claim 1, wherein determining the fixation distance is performed by acquiring the distance, in the direction of the user's gaze, to a 3D mesh map.

7. The method according to claim 4, comprising, maintaining said position of the HUD UI, while the user continues to look at the HUD.

8. The method according to claim 1, wherein dynamically adjusting said HUD is performed during saccades.

9. A Head-Mounted-Device, HMD, for adaptively adjusting a Head-Up-Display, HUD, wherein the HUD comprises:
a User Interface, UI;
the HMD comprising at least one eye tracker; and
a processor and a memory containing instructions executable by the processor wherein the HMD is operative to:
determine a fixation distance, being a distance to a fixation point a user of said HUD is fixating on;
dynamically adjust said HUD by:
adjusting the position of the HUD UI, in front of each eye of the user, such that the HUD UI appears to be positioned at the fixation distance.

10. The HMD according to claim 9, is operative to dynamically adjust said HUD by adjusting the position of the HUD UI, by maintaining the HUD UI at approximately the same visual size in the user's field of view.

11. The HMD according to claim 9 is operative to dynamically adjust said HUD by moving, in a virtual space, the HUD UI to the fixation distance; and by scaling the size of the HUD UI to maintain approximately the same visual size in the user's field of view as before said moving, wherein scaling is performed by multiplying a HUD scale by the fixation distance.

12. The HMD according to claim 9 is operative to determine the fixation distance by using an intersection of or a minimal distance between gaze rays originating from the left and right eye, respectively.

13. The HMD according to claim 9 is operative to determine the fixation distance by using an Inter-Pupillary-Distance, IPD, between the pupils of the user, an Inter-Ocular-Distance IOD, between the eyes of the user, and an approximation of the eyeball diameter of each of the eyes.

14. The HMD according to claim 9 is operative to determine the fixation distance by acquiring by acquiring the distance, in the direction of the user's gaze, to a 3D mesh map.

15. The HMD according to claim 9 is operative to maintain said position of the HUD UI while the user continues to look at the HUD.

16. The HMD according to claim 9 is operative to dynamically adjust said HUD during saccades.

17. The HMD according to claim 9 wherein the HUD is rendered on a fixed focus display or an adaptive focus display.

18. A computer program comprising instructions which when executed on at least one processor of an HMD comprising:
a User Interface, UI;
the HMD comprising at least one eye tracker; and
a processor and a memory containing instructions executable by the processor wherein the HMD is operative to:
determine a fixation distance, being a distance to a fixation point a user of said HUD is fixating on;
dynamically adjust said HUD by:
adjusting the position of the HUD UI, in front of each eye of the user, such that the HUD UI appears to be positioned at the fixation distance; and
wherein the instructions cause the at least said one processor to carry out the steps of:
determining a fixation distance, being a distance to a fixation point a user of said HUD is fixating on;
dynamically adjusting said HUD by:
adjusting the position of the HUD UI, in front of each eye of the user, such that the HUD UI appears to be positioned at the fixation distance.

19. A carrier containing the computer program according to claim 19, wherein the carrier is one of a computer readable storage medium; an electronic signal, optical signal or a radio signal.
